(19) United States
(12) Patent Application Publication
(10) Pub. No.: US 2003/0005466 A1
(43) Pub. Date: Jan. 2, 2003

(54) Content personalization system for mobile users

(76) Inventor: Hsinchao Liao, Berkeley, CA (US)

Correspondence Address: HSINCHAO LIAO, P. O. BOX 5644, BERKELEY, CA, 94705-0644, US

(21) Appl. No.: 09/896,727

(22) Filed: Jun. 29, 2001

(51) Int. Cl. H04N 7/16

(52) U.S. Cl. 725/141; 725/133; 725/134; 725/153; 725/142

(57) ABSTRACT

A broadcast receiver (10) containing an embedded computer (26) receives digital content such as news, sports, weather and stocks. The broadcast receiver personalizes, i.e. filters and processes, the content received according to the user-chosen configuration software (82) loaded from a removable storage device (80), such as a compact flash card. The broadcast receiver displays, announces or writes to the same removable storage device the desired content. Without needing any user interaction, this broadcast receiver is well suited for the mobile environment. An interactive computer (70), as instructed by its user, writes the configurable software, including parameters, software and firmware updates to the removable storage device. The interactive computer optionally downloads the configurable software, for example, the personal stock portfolio of its user, from Internet.

### FEDERALLY SPONSORED RESEARCH

Not applicable

### SEQUENCE LISTING OR PROGRAM

Not applicable

### BACKGROUND OF THE INVENTION

1. Field of the Invention

The invention relates to the mobile implementation of content personalization.

2. Descript of the Prior Art

Several Internet services provide personalized content including stock quotes, local weather, news headlines, and sports scores. See, for example, my.yahoo.com. Mobile implementations are typically based on cellular networks. For example, Semotus Solutions Inc., formerly DataLink Systems Corporation of Canada, provides the QuoteXpress service. It transmits personalized stock quotes and alerts to pagers and personal cellular service (PCS) devices. However, QuoteXpress does not transmit data to each receiver continuously. A user is limited to one set of updates in each of the 46 predetermined time windows. Some other services use wireless connections through cellular or proprietary networks to provide mobile access to Internet and the online personalization services. Usage of these cellular and paging services requires a subscription and its associated fee. These services can support only limited numbers of receivers and subscribers. These limits are imposed by, for example, the number of valid telephone numbers and by the number of allowable concurrent connections within each network cell.

An alternative solution uses receivers pre-configured by their users to filter and process continuous broadcast data in real-time.

One suitable mode of broadcast transmission uses subcarriers. Many systems transmit digital data using FM radio and television subcarriers. Services such as DeskTop Data, Inc. of Waltham, Mass. use subcarriers to transmit financial information. The radio data system (RDS) in Europe and the radio broadcast data system (RBDS) in the USA have been widely implemented to broadcast station and program information. The Subcarrier Traffic Information Channel (STIC) developed by Mitre Corp. is used for broadcasting traffic conditions. Personal messaging services such as that provided by CUE Corporation of Irvine, Calif. also use subcarrier broadcast. In Japan and Europe, FM Mutiplex is the more common name given to the broadcast of digital data and graphics over FM subcarriers using the DAta Radio Channel (DARC) standard. Another version of DARC is available over amplitude modulation (AM). A multi-carrier version of DARC is disclosed in U.S. patent application Ser. No. 08/579,144 and briefly described in the white paper titled “SKYSPEED: A HIGH SPEED FM SUBCARRIER NETWORK FOR INTERNET APPLICATIONS” released by CUE Corp. on Jan. 7, 2000. See also U.S. Pat. No. 6,057,808, No. 5,734,780, No. 5,963,563 and No. 6,081,699.

The performance of subcarrier broadcast can be summarized by the following estimates for DARC FM. A stock quote consisting of a stock symbol and a number can be reported using about 10 characters or 10 bytes. Each data record needs approximately 10 additional bytes to encode content provider identification and data classification. Hence, for each stock quote, approximately 20 bytes (160 bits) of data are broadcasted. Since DARC FM systems can effectively transmit data, with error correction, at approximately 8 kilobits per second (kbps), about 50 quotes can be broadcasted per second or 3,000 quotes per minute. Thus all symbols listed on NASDAQ and NYSE can be broadcasted in two to three minutes, or less than one minute if compression techniques are used. Thus any personal portfolio can be fully updated in one minute using subcarrier broadcast.

The problem that remains is that of providing personalized views of the broadcast data. Prior inventions use databases and interactive computers to process received data. Various methods of input by the user to the receiver have been disclosed. U.S. Pat. No. 5,406,626, No. 5,406,626, No. 5,590,195 and No. 5,751,806 disclose a system where the user uses voice commands and push buttons to navigate through menus. Internet RadiOH of Infodia Co., Ltd. of Korea uses pen-based input. After some interaction with the user interface, the desired result is finally displayed or announced.

There are two disadvantages to these systems. First, memory is wasted because all received data, including all unwanted data, is entered into the database. It is more memory efficient to filter the data according to the user's preferences as they are being received so that only data desired by the user are stored.

Second, in the mobile environment, the amount of interaction required to operate one of these systems is a safety hazard. The only devices that do not require interaction with their users are beepers and pagers. Radio paging services use phase-shifting techniques (e.g. PSK and BPSK) to personalize data. See for example, U.S. Pat. No. 4,816,769. However, similar to cellular services, because private data is included in the broadcast, each pager must occupy a distinct portion of the allocated bandwidth to deter eavesdropping. Thus the number of users concurrently receiving data is limited; and therefore, data is available in discrete time windows rather than continuously.

It is worth noting that the problem of presenting a personalized view of public data is very different from the problem of enabling mobile access to private data. The solutions to the latter problem, for example personal pagers and smart card commerce systems, must include security measures for the protection of privacy. In contrast, security measures are taken for the first problem only to deny access by non-subscribers. Thus if the provider's revenue is not based on subscriptions, the security measures can be minimized or even eliminated to improve data throughput.

3. Objects and Advantages

The goal is to present a personalized view of broadcast content to the mobile user. The present invention meets this goal with these objects and advantages:

(a) to enable the user to personalize his or her own view of broadcast content through minimal interaction with the mobile system;

(b) to enable the user to synchronize personalization settings of the mobile service with an Internet service so that he or she can obtain the same personalized content using either service;

(c) to provide mobile units each of which can be shared by unlimited number of users; and

(d) to provide a system that can be implemented with existing technologies.

### SUMMARY

A system for presenting personalized content comprises a mobile receiver unit, a removable storage device and the necessary hardware and software for managing this device. The system personalizes broadcast content received by the receiver in accordance with parameters stored on the removable storage device. The system optionally displays, announces and stores the personalized content.

The removable storage device is programmed by an interactive computer whose software is supplied by the content provider who may choose to unify the service with that of an Internet personalized content provider. The storage device contains personalization parameters such as a stock portfolio, a listing of favorite baseball teams, a favorite voice to use with the receiver's speech synthesizer etc. In addition, the storage device may contain firmware updates and other software for the receiver.

Each receiver of this system is readily shared by an unlimited number of users through the use of separate storage devices. The user interface of the simplest receiver consists of the removable storage device receptacle and optionally, a switch that controls audio output. The shareability and the minimal user interface of the receiver are most valuable in the mobile environment.

The receiver can be integrated with a automobile stereo especially in the case where radio subcarrier broadcast technology is used, or manufactured as a standalone unit.

### BRIEF DESCRIPTION OF THE DRAWING

FIG. 1 shows a block diagram of one embodiment of the mobile receiver unit in accordance with the present invention, in conjunction with the removable storage device that stores personalization parameters and the hardware that manages this device.

### REFERENCE NUMERALS IN THE DRAWING

10 Mobile receiver unit

20 Antenna

22 Demodulator

24 Digital data

26 Embedded computer

28 Personalized content

32 Data ready indicator (LED)

34 Video display

36 Loudspeaker or earphone

40 Audio power amplifier

46 Synthesized audio signal

48 Voice synthesizer

50 Input selector switch

60 Internet personalized content service

62 Internet connection

70 Interactive computer

80 Removable storage device

82 Personalization and system parameters and programs

90 Other audio inputs

### DETAILED DESCRIPTION OF THE INVENTION

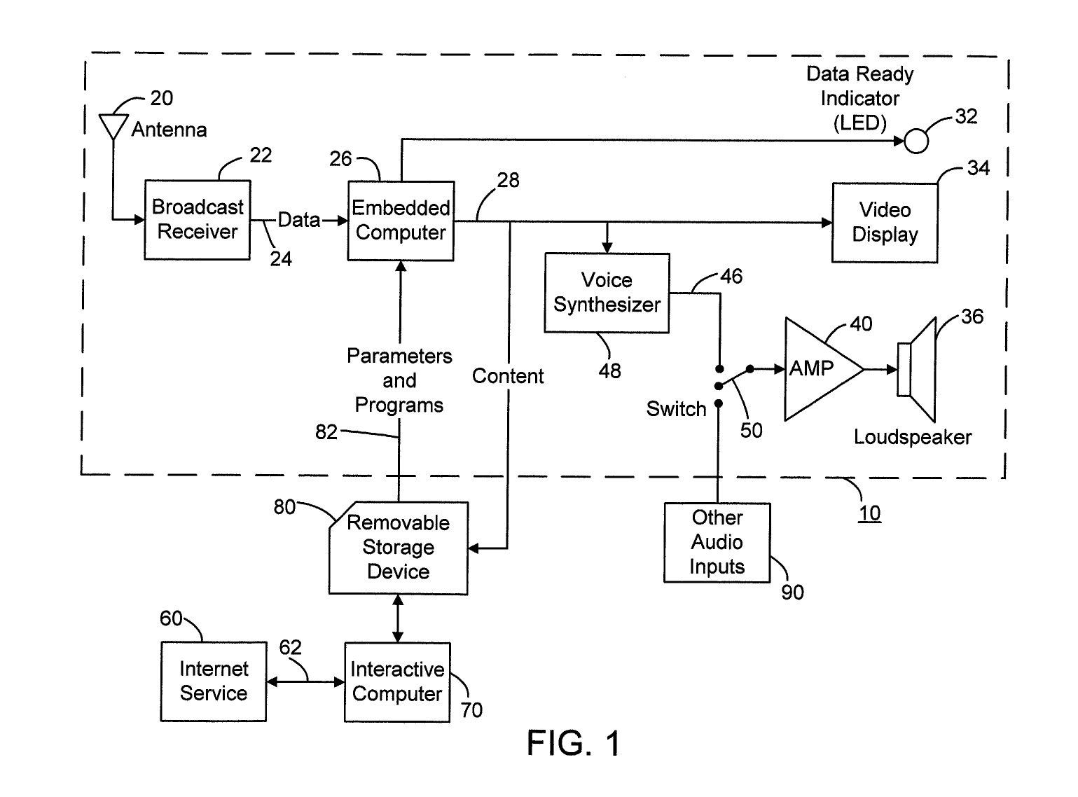

FIG. 1 shows a system in accordance with one embodiment of the present invention. It consists of mobile receiver unit 10, removable storage device 80 and interactive computer 70. Interactive computer 70 writes personalization and system parameters, and system programs 82 to removable storage device 80. Interactive computer 70 optionally synchronizes these parameters with, and downloads updated software from online personalized content service 60 through Internet connection 62.

Referring to mobile receiver unit 10 in FIG. 1, antenna 20 provides a broadcast signal to demodulator 22, which converts this broadcast signal to digital data 24, which is processed by embedded computer 26. In the case where radio or television broadcast is used, demodulator 22 may be combined with a common analog tuner.

Embedded computer 26 takes as its input broadcast digital data 24 and personalization and system parameters 82 that are stored on removable storage device 80. Embedded computer 26 minimally requires a processor and the hardware and firmware for accessing device 80. Embedded computer 26 may contain additional rewritable memory that is not necessary if device 80 is rewritable, has enough capacity, and can be accessed quickly in real-time by embedded computer 26. This extra memory is clearly necessary if personalization is required to continue after device 80 is detached.

In the preferred embodiment, where device 80 is a compact flash card or another memory device of similar physical size, embedded computer 26 is physically no larger than a pocket-sized digital camera and technologically no more complex than a hand-held computer without the keyboard, writing implement or any interactive input component.

Device 80 contains system and personalization parameters 82. The personalization parameters chosen by the user typically specify the user's stock portfolio, the user's favorite sports, teams etc. Additional parameters may be chosen by the content provider's software to personalize advertising content. Embedded computer 26 uses these personalization parameters to filter digital data 24 and produce personalized content 28. Embedded computer 26 discards immediately any content that does not fit the personalization parameters.

Personalization is not limited to data filtration. In one embodiment, embedded computer 26 interprets programs stored on device 80 for processing digital data 24. For example, embedded computer 26 may execute a program that converts all temperature measures in degrees Celsius to degrees Fahrenheit. Embedded computer 26 may implement an event-driven system in which user-specific conditions that trigger audio and visual alerts are specified as programs stored on device 80.

In one embodiment, embedded computer 26, upon attachment of device 80, configures itself and other components of receiver 10 with system programs and system parameters 82 stored on device 80. One system parameter controls whether personalization stays in effect when the user detaches device 80 from mobile receiver unit 10. A second parameter selects the preferred voice that voice synthesizer 48 generates. Other parameters control various functions of voice synthesizer 48 and video display 34. One category of system programs consists of parser programs specific to the content providers. By loading these programs from device 80 and executing them, embedded computer 26 is able to interpret different data formats, thus allowing receiver 10 to be used with more than one content provider.

Embedded computer 26 may be programmed to save a user-selected subset of personalized content 28 to device 80. For example, the user may instruct embedded computer 26, through a simple program stored on device 80, to store the highest and lowest prices of each stock in the user's portfolio that receiver 10 has received each day.

Video display 34 is the default output venue of receiver 10. In one compact embodiment, the content is displayed in a small LCD of the types typically found on automobile stereos and personal pagers. System parameters that control the scrolling of text, the length of the pause between displaying consecutive units of content, etc., are stored on device 80.

Audio output is essential in mobile devices. Voice synthesizer 48 produces analog audio signals 46 from digital personalized content 28. Analog audio signals 46 are provided to audio power amplifier 40, which drives loudspeakers or earphones 36 to which the user listens. In the case of loudspeakers, the user can turn on and off the audio output using switch 50. Volume and other audio controls are part of standard audio equipment; they are not shown in FIG. 1. In one embodiment where receiver 10 is integrated with a personal stereo or an automobile stereo that facilitates other audio inputs 90, audio power amplifier 40 and loudspeakers 36 are shared between the stereo and voice synthesizer 48. Hence in this integrated embodiment, switch 50 is provided to the user for selecting the desired audio input.

Embedded computer 26 switches on data ready indicator LED 32 whenever it receives error-free digital data 24, regardless of whether the system is initialized and regardless of whether the parser program is loaded. LED 32 serves two purposes. First it notifies the user that digital data is available for personalization and reminds the user to attach device 80. Second, for branding purpose, LED 32 can be masked in the shape of one of the trademarks belonging to the manufacturer or a content provider.

In one embodiment, device 80 contains multiple profiles, i.e. sets of parameters and programs. For example, the user may store two distinct investment portfolios for use with one content provider and a third portfolio for use with another content provider. One system parameter specifies the default profile to be used with each content provider. Embedded computer 26 personalizes content using the default profile of each content provider whenever data from that content provider is received. Using a selector on mobile receiver unit 10, the user can override the profile chosen by embedded computer 26.

In the preferred embodiment, where removable storage device 80 contains only one profile, the user switches profiles by replacing device 80 with another. The trade off is between carrying extra compact flash cards and having an extra switch on mobile receiver unit 10.

In one embodiment, receiver 10 operates without device 80 having been attached. In this embodiment, embedded computer 26 is installed with a default behavior. For example, embedded computer 26 may be programmed to display advertising, if it is being received from a known content provider, continuously and repeatedly until device 80 is attached. Upon attachment of removable storage device 80, embedded computer 26 may load and execute new programs, configure the display according to parameters, perform personalization of received content, etc, as described previously.

Interactive computer 70 writes software to device 80 for use with receiver 10. Using any input device such as a keyboard, a writing implement, touch screen, etc, the user selects any number of personalization settings and programs to be applied to the broadcast data received by receiver 10. In addition, the content provider may store extra parameters for targeted advertising. These parameters are hidden from the user and may not be altered by the user.

The content provider may enable interactive computer 70 to synchronize personalization parameters stored on device 80 with the online parameters for the user's Internet personalized content service 60. For content categories available on both Internet and broadcast, these synchronized parameters ensure that receiver 10 provides the same personalized content as the Internet service. The parameters for targeted advertisement can be downloaded from Internet as well, perhaps in collaboration with an e-commerce analyst who monitors and predicts the user's Internet shopping behavior. In this embodiment, the user may only need to interact with the Internet service. The programming of device 80 requires only a confirmation, possibly with one click of a button, by the user.

The content provider may provide programs to the user for processing data received by receiver 10. As mentioned previously, some of these programs perform temperature scale conversion, archival of highest and lowest stock prices, etc. In addition to ready-built programs, the content provider may provide one or more programming environments to the user for building his or her own programs using interactive computer 70. The programming environment may be built as an Internet application so that interactive computer 70 is only required to execute an Internet browser program. The programs selected by the user are written to device 80 and executed by embedded computer 26.

The results, written to removable storage device 80 by embedded computer 26 as instructed by the user-selected programs, can be processed further by any machine capable of reading data from device 80.

The behavior of embedded computer 26 can be specified as three processes: a configuration process, a personalization process and an output process. The configuration process sets up receiver 10 according to the system parameters and initializes the data structure for storing personalized data. The configuration process may also update the system firmware and the programs that implement any of these three processes, including itself. The personalization service filters and performs custom processing on digital data 24 according to the personalization parameters and programs 82 stored on device 80. The output process traverses the personalization data structure and delivers units of personalized content to video display 34 and voice synthesizer 48.

The configuration process sets a “system ready” flag whenever it has finished initializing the system. If receiver 10 is configured to retain personalization settings after removable storage device 80 is detached, then the configuration process removes this “system ready” flag when device 80 is attached. Otherwise, the configuration process removes this flag when device 80 is detached. The personalization and output processes perform their functions only when this “system ready” flag is set.

The personalization process locks the personalization data structure before it stores a unit of content and its corresponding checksum into this structure. It unlocks the structure when it has finished storing the content or as soon as it detects the absence of the “system ready” flag. To reinitialize the system, for example when the user attaches device 80, the configuration process first removes the “system ready” flag; then it waits for the personalization process to unlock the data structure; and then it initializes receiver 10 and the personalization data structure.

The output process does not respect the lock on the personalization data structure. While “system ready” flag is set, the output process continuously traverses the personalization data structure. It outputs any unit of content that has a valid checksum computed and stored by the personalization process. The output process is idle when the “system ready” flag is absent.

The asynchronous nature of the output process enables it to execute at a configurable pace. A user-specified system parameter stored on device 80 controls the length of the pause between consecutive units of content. Other system parameters hidden from the user determine when advertisements are displayed or announced.

The broadcast data must follow some simple requirements. Each unit of content must identify its content provider and a sequence of categorization keys. For example, one such sequence of keys might be “sports, college football”. Using numeric codes for these keys would naturally compress the data and increase data throughput. In the case of free-form text categories such as news and advertisement, each unit of content must contain a unique identifier. These identifiers enable the personalization process to identify and discard duplicated content.

A user of a personalized news service would typically request some number of top stories in each category, for example, the top five stories in entertainment. Thus each headline must include a ranking. The rankings enable the personalization process to discard headlines of relatively little importance and to replace old headlines with new ones.

A content provider may enforce additional data formatting requirements through the software it distributes.

I claim:

1. A mobile receiver unit for receiving from broadcast and personalizing digital data, comprising
a broadcast receiver for demodulating digital data from broadcast signal; and
an embedded computer, including an interface for accessing a removable storage device, for processing the demodulated digital data according to the software stored on said removable storage device attached to said embedded computer through said interface.

2. The apparatus of claim 1, wherein said embedded computer loads from said removable storage device software containing parameters.

3. The apparatus of claim 1, wherein said embedded computer loads from said removable storage device software containing programs.

4. The apparatus of claim 1, wherein said embedded computer includes a signaling means for alerting the user that demodulated digital data is available.

5. The apparatus of claim 1, further comprising a video display for displaying digital data.

6. The apparatus of claim 5, wherein said video display comprises a pacing means for displaying content with a plurality of pause lengths.

7. The apparatus of claim 6, wherein said pacing means includes selection of pause lengths through software stored on said removable storage device.

8. The apparatus of claim 1, further comprising an audio output system including a voice synthesizer for converting digital data to analog audio signals.

9. The apparatus of claim 1, further comprising an integrating means for connecting to a device selected from a group consisting of an automobile stereo, a personal stereo and a radio tuner.

10. A personalization system, comprising
an interactive computer, including an interface for accessing a removable storage device, for providing to the user an interactive means for choosing interactively a subset of a collection of personalization software, and for writing said collection of personalization software to said removable storage device; and
a mobile receiver unit for receiving from broadcast and personalizing digital data, comprising
a broadcast receiver for demodulating digital data from broadcast signal; and
an embedded computer, including an interface for accessing said removable storage device, for processing the demodulated digital data according to said collection of personalization software stored on said removable storage device attached to said embedded computer through said interface.

11. The system of claim 10, wherein said interactive computer is a machine selected from the group consisting of desktop computers, laptop computers, handheld computers, television set top boxes and interactive television sets.

12. The system of claim 10, wherein said interactive computer writes to said removable storage device software containing parameters.

13. The system of claim 12, wherein said interactive computer includes a synchronizing means for synchronizing parameters stored on said removable storage device with the parameters used by a service selected from the group consisting of Internet personalization services and interactive television services.

14. The system of claim 10, wherein said interactive computer writes to said removable storage device software containing programs.

15. The system of claim 14, wherein the interactive computer includes a downloading means for downloading programs from Internet to said removable storage device.

16. The system of claim 14, wherein said interactive computer includes a programming means for identifying and building, by the user, programs to be executed by said embedded computer of said mobile receiver unit.
